(19) United States
(12) Patent Application Publication
(10) Pub. No.: US 2025/0198703 A1
(43) Pub. Date: Jun. 19, 2025

(54) ENERGY CONVERSION METHOD USING RESIDUAL HEAT FROM STEEL PRODUCTION

(71) Applicant: Nucor Corporation, Charlotte, NC (US)

(72) Inventor: Lindsay Leveen, Sausalito, CA (US)

(73) Assignee: Nucor Corporation, Charlotte, NC (US)

(21) Appl. No.: 18/980,959

(22) Filed: Dec. 13, 2024

Related U.S. Application Data
(60) Provisional application No. 63/610,865, filed on Dec. 15, 2023.

(51) Int. Cl. F27D 17/10; F23G 7/07; F27D 17/20

(52) U.S. Cl. CPC F27D 17/102; F23G 7/07; F27D 17/20

(57) ABSTRACT

A system to convert a renewable lower energy material to a higher energy material using residual heat from a steel processing unit is provided. A system comprising a flow through catalytic reactor that selectively catalytically converts methanol into a hydrogen and carbon monoxide stream utilizing a steel processing unit's residual heat, and the subsequent separation and collection and storage of hydrogen with the introduction of the separated carbon monoxide stream into the steel processing unit so as to replace or reduce carbon sources, is also disclosed.

### CROSS-REFERENCE TO RELATED APPLICATIONS

This application claims the benefit of U.S. Provisional Application No. 63/610,865 filed on Dec. 15, 2023, the entirety of which is incorporated herein by reference.

### TECHNICAL FIELD

This disclosure is directed to energy conversion, for example, conversion of a first material of a first heat value to a second material of a heat value greater than the first heat value. Systems and methods of using residual heat from steel processing to convert methanol to hydrogen are disclosed.

### BACKGROUND

Methanol is a versatile energy source that can be used either directly as a fuel or indirectly as a latent hydrogen storage material. As a hydrogen source, methanol has several advantages over competing hydrogen storage technologies, e.g., the liquid phase of methanol at room temperature (RT) makes it easy to handle and compatible with the currently prevalent distribution infrastructures; methanol has a high H/C ratio and thereby large gravimetric and volumetric hydrogen storage capacity of 12.5 wt % and 99 kg/m3, respectively, and is available from renewable sources and/or biomaterials. Four chemical processes can be used to produce hydrogen from methanol, namely, methanol decomposition, methanol partial oxidation, methanol steam decomposition, and autothermal methanol decomposition (oxidative steam decomposition). These methanol to hydrogen chemical reactions are presented in eqs 1-4, respectively:

CH₃OH→2H₂+CO (1)

CH₃OH→½I₂+CO₂+2H₂ (2)

CH₃OH+H₂O→CO₂+3H₂ (3)

4CH₃OH+3H₂O+½O₂→4CO₂+11H₂ (4)

As such, methanol appears to be attractive from an energy self-sufficiency point of view for use as a storable liquid fuel for generating hydrogen.

### SUMMARY

In examples, an energy conversion system is provided, the system comprising: a steel processing unit having a residual heat source; at least one conversion reactor configured to receive a first material having a first heating value, the at least one conversion reactor being coupled to the residual heat source, the at least one conversion reactor configured to catalytically convert the first material to a second material having a second heating value greater than the first heating value.

In aspects, the residual heat source is from off gas. In aspects, alone or in combination with any previous aspect, the residual heat source is inductively, convectively, or radiatively transferred.

In aspects, alone or in combination with any previous aspect, the steel processing unit is an electric arc furnace. In aspects, alone or in combination with any previous aspect, the steel processing unit is a blast furnace. In aspects, alone or in combination with any previous aspect, the steel processing unit is direct reduction unit.

In aspects, alone or in combination with any previous aspect, the first material is methanol. In aspects, alone or in combination with any previous aspect, the first material is methanol derived from biomaterial. In aspects, alone or in combination with any previous aspect, the first material is heated prior to being received by the at least one conversion reactor. In aspects, alone or in combination with any previous aspect, the first material is heated to a temperature from ambient to about 180° C. prior to being received by the at least one conversion reactor. In aspects, alone or in combination with any previous aspect, the first material is vaporized prior to being received by the at least one conversion reactor.

In aspects, alone or in combination with any previous aspect, the second material is hydrogen In aspects, alone or in combination with any previous aspect, the system further comprises collecting or storing the hydrogen.

In aspects, alone or in combination with any previous aspect, the at least one conversion reactor is configured to continuously or semi-continuously receive the first material.

In aspects, alone or in combination with any previous aspect, the at least one conversion reactor is thermally coupled to the steel processing unit. In aspects, alone or in combination with any previous aspect, the at least one conversion reactor is heated to a temperature from 180° C. to 800° C. In aspects, alone or in combination with any previous aspect, the at least one conversion reactor is configured to receive the first material at a temperature from ambient to about 180° C.

In aspects, alone or in combination with any previous aspect, the at least one conversion reactor comprises a catalyst comprising copper or chromium. In aspects, alone or in combination with any previous aspect, the at least one conversion reactor comprises a catalyst selected from copper-zinc, copper-chromium or zinc-chromium.

In aspects, alone or in combination with any previous aspect, the at least one conversion reactor is configured to catalytically convert the first material to a third material. In aspects, alone or in combination with any previous aspect, the system further comprises introducing the third material to the steel processing unit. In aspects, alone or in combination with any previous aspect, the third material is carbon monoxide.

In a second example, a method is provided, the method comprising: providing at least one conversion reactor thermally coupled to a residual heat source of a steel processing unit; receiving a first material having a first heating value; catalytically converting the first material to a second material having a second heating value greater than the first heating value.

In aspects, the steel processing unit is an electric arc furnace. In aspects, alone or in combination with any previous aspect, the steel processing unit is a blast furnace. In aspects, alone or in combination with any previous aspect, the steel processing unit is direct reduction unit.

In aspects, alone or in combination with any previous aspect, the first material is methanol. In aspects, alone or in combination with any previous aspect, the first material is methanol derived from biomaterial. In aspects, alone or in combination with any previous aspect, the method further comprises heating the first material prior to being received by the at least one conversion reactor.

In aspects, alone or in combination with any previous aspect, the first material is heated to a temperature from ambient to about 180° C. prior to being received by the at least one conversion reactor. In aspects, alone or in combination with any previous aspect, the method further comprising vaporizing the first material prior to being received by the at least one conversion reactor.

In aspects, alone or in combination with any previous aspect, the second material is hydrogen. In aspects, alone or in combination with any previous aspect, the method further comprises collecting or storing the hydrogen.

In aspects, alone or in combination with any previous aspect, the at least one conversion reactor is configured to continuously or semi-continuously receive the first material.

In aspects, alone or in combination with any previous aspect, the method further comprises heating the at least one conversion reactor to a temperature from 180° C. to 800° C.

In aspects, alone or in combination with any previous aspect, the at least one conversion reactor comprises a catalyst comprising copper or chromium. In aspects, alone or in combination with any previous aspect, the at least one conversion reactor comprises a catalyst selected from copper-zinc, copper-chromium or zinc-chromium.

In aspects, alone or in combination with any previous aspect, the further comprising catalytically convert the first material to a third material. In aspects, alone or in combination with any previous aspect, the method further comprising introducing the third material to the steel processing unit. In aspects, alone or in combination with any previous aspect, the third material is carbon monoxide.

In a third example, a method of reducing or eliminating solid carbon introduction into a steel process is provided, the method comprising: providing at least one conversion reactor thermally coupled to a residual heat source of a steel processing unit; receiving methanol in the at least one conversion reactor; catalytically converting the methanol to a carbon monoxide stream and a hydrogen stream; separating the carbon monoxide stream from the hydrogen stream; and introducing the carbon monoxide stream into the steel processing unit so as to reduce or eliminate solid carbon introduction.

In aspects, the steel processing unit is an electric arc furnace.

In aspects, the steel processing unit is a blast furnace. In aspects, alone or in combination with any previous aspect, the steel processing unit is direct reduction unit. In aspects, alone or in combination with any previous aspect, the first material is methanol derived from biomaterial.

In aspects, alone or in combination with any previous aspect, the method further comprises heating the methanol prior to being received by the at least one conversion reactor. In aspects, alone or in combination with any previous aspect, the methanol is heated to a temperature from ambient to about 180° C. prior to being received by the at least one conversion reactor. In aspects, alone or in combination with any previous aspect, the method further comprises vaporizing the methanol prior to being received by the at least one conversion reactor.

In aspects, alone or in combination with any previous aspect, the the at least one conversion reactor is configured to continuously or semi-continuously receive the methanol and continuously or semi-continuously produce the carbon monoxide stream and the hydrogen stream.

In aspects, alone or in combination with any previous aspect, the method further comprises heating the at least one conversion reactor to a temperature from 180° C. to 800° C.

In aspects, alone or in combination with any previous aspect, the at least one conversion reactor comprises a catalyst selected from copper-zinc, copper-chromium or zinc-chromium. In aspects, alone or in combination with any previous aspect, the method further comprises collecting or storing the hydrogen stream.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 is schematic of an exemplary energy conversion system as disclosed herein.

FIG. 2 is a cross section of an exemplary catalytic reactor as disclosed herein.

FIG. 3 is a side sectional view of the exemplary catalytic reactor of FIG. 2.

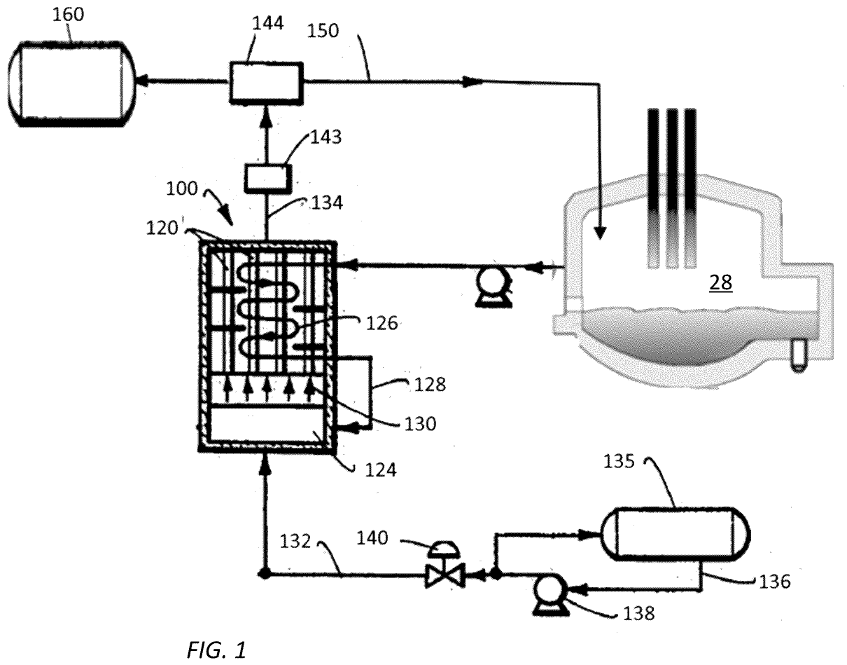

### DETAILED DESCRIPTION

A system to convert a renewable lower energy material to a higher energy material using residual heat from a steel processing unit is provided. A system comprising a flow through catalytic reactor that selectively catalytically converts methanol into a hydrogen and carbon monoxide utilizing a steel processing unit's residual heat, and the collection and storage of hydrogen with the introduction of carbon monoxide into the steel processing unit so as to replace or reduce carbon sources is also provided.

The direct decomposition of 1 mole of methanol (a lower energy material) into 2 moles of hydrogen (a higher energy material) and 1 mole of carbon monoxide represents a convenient cycle for generating hydrogen-rich gas from liquid methanol:

CH₃OH→2H₂(g)+CO(g)

Methanol contains a lower heating value of about 20 Mj/kg than hydrogen's heating value of about 24 Mj/kg. The 20% increase in heat content of the dissociated methanol products is derived from the endothermic reaction of equation (1) where energy is consumed in the cleavage of hydrogen-carbon and hydrogen-oxygen chemical bonds to produce hydrogen and carbon monoxide.

To facilitate this endothermic chemical reaction and further enhance the system energy gain, latent heat of a temperature range from 200° C. to 650° C. can be used. In examples, the latent heat from steel processing units or equipment is used. For example, a typical scrap steel load of about 120 tons uses about 720 KW/h and can produce about 226 KW/h of hot off gas, which is more than enough to heat a catalytic reactor configured to accept at least some of this heat and use it to catalytically decompose methanol to a source of hydrogen. In addition, in examples, the carbon monoxide that is also produced during the methanol decomposition is introduced to the steel processing unit to reduce or eliminate the use of solid carbon, such as anthracite. Thus, a carbon capture method is provided where carbon from methanol, e.g., a bio-based methanol, is captured in steel, which is recyclable.

In examples, a catalyst is utilized to inhibit the formation of carbon and to facilitate the decomposition reaction at lower temperatures by controlling the mechanism by which the methanol molecule reacts. The catalyst must be capable of operation at temperatures up to 800° C. (1472° F.), under pressures below 1000 kPa. In examples, minimum conversion of 80% is considered acceptable under maximum flow conditions. In examples, the catalyst is chosen such that the selectivity of methanol decomposition (to hydrogen and carbon monoxide) over dehydration to dimethyl ether (2CH₃OH→CH₃OCH₃+H₂O) under the various operating conditions.

A system using latent heat from steel processing in combination with a methanol-decomposition reactor is provided in accordance with this disclosure. The reactor can be efficiently and reliably operated at temperatures in the range of 150 to 800 degrees C. with essentially no production of soot or particulate matter. Thus, in accordance with this disclosure, the methanol-decomposition reactor is operated under catalytic conditions using heat from a steel processing unit to produce a hydrogen-rich gas stream while reducing or eliminating production of solid carbon below the temperature ranges of latent heat available under normal operation of steel processing equipment.

In examples, the methanol-decomposition reactor of this disclosure combines the effective utilization of heat generated during steel processing by means of proper design to enhance heat transfer into the catalyst of the methanol-decomposition reactor, and a catalyst that will efficiently and selectively dissociate methanol under all operating conditions encountered while maintaining high activity and structural integrity.

In examples, the catalyst of the methanol-decomposition reactor has a flow-through decomposition zone which contains a porous bed of solid, selective, decomposition catalyst, the decomposition zone being thermally coupled to heat provided by the steel processing equipment. In examples, the steel processing equipment provides heat to the decomposition zone at temperatures between 200° and 650° C., which results in the decomposition of methanol to produce a hydrogen gas and a carbon monoxide gas.

In examples, liquid methanol is vaporized and preheated in a vaporizer prior to introduction into the decomposition reactor. In examples, the vaporizer receives the heat necessary for vaporization of the methanol from off gases before or after they thermally interact with the decomposition reactor.

In examples, the heat produced by the steel processing equipment provides means for heating the decomposition zone and/or used by the vaporizer in vaporizing the methanol and heating the vapors therefrom.

Since the decomposition of methanol is an endothermic reaction, the thermal energy required for this conversion is stored in the fuel as potential chemical energy in the form of hydrogen and carbon monoxide. Therefore, the thermal efficiency of the methanol-converter system is increased by the amount of thermal energy extracted from the heat from the steel processing equipment for the vaporization and decomposition of methanol.

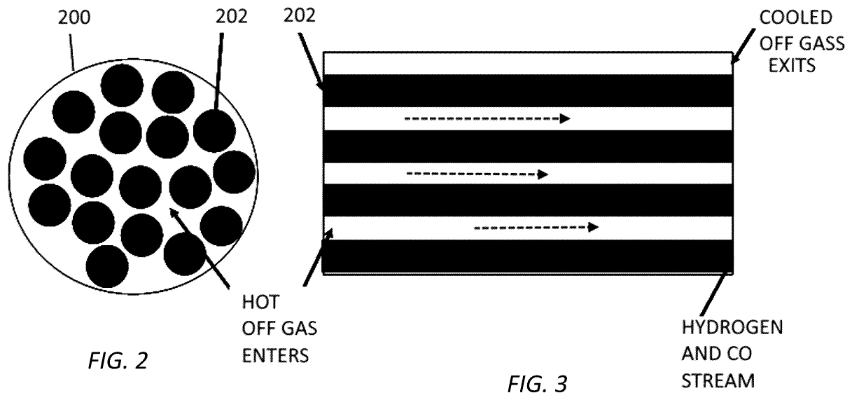

The present disclosure utilizes selective catalysts to produce a product gas containing only hydrogen and carbon monoxide at the lower off gas temperatures of 200° to 650° C. In examples, an exemplary catalytic reactor of the present disclosure is shown in both FIGS. 2 and 3. In FIG. 2 the catalytic reactor is used in combination with an electric arc furnace (EAF) and in FIG. 3 the catalytic reactor is used in combination with a direct reducing iron (DRI) system. The methanol converter system in both FIGS. 2 and 3 are identical and the same numbers will be used for their identification.

In examples, an exemplary catalytic reactor of the presently disclosed system is shown generally at 100 in FIGS. 2 and 3. In examples, the catalytic reactor 100 is divided into a flow-through zones defined by elongated tubes 120 and an optional vaporizer 124.

In examples, elongated tubes 120 contain the catalyst in any type and/or form which will be described in detail later. In examples, the elongated tubes 120 are heated directly or indirectly by the steel processing equipment, for example, using a coupled conduit 16 for receiving off gases for example, that are configured to flow past outer surfaces of elongated tubes 120 as indicated by line 126. In examples, as the off gases travel from the top of the elongated tubes 120 to the bottom as indicated by the arrows along line 126, heat transfer occurs and the off gases become partially cooled. In examples, the partially cooled off gases are then passed via access 128 to the vaporizer 124 where residual heat remaining in the off gas is used to vaporize liquid methanol entering the vaporizer 124. It should be understood that the present disclosure is not limited to methanol as a hydrogen storage material, rather methanol is used to exemplify the present disclosure.

In examples, during operation, methanol is introduced into the vaporizer 124 via feedline 132. The vaporizer 124 vaporizes at least a portion of the liquid methanol fuel which flows through the elongated tubes containing heated catalyst (as indicated by arrows 130) where it is decomposed to a hydrogen-rich stream which is transported from the catalytic reactor by conduit 134 to separation unit 160 where the hydrogen is separated (e.g., cryogenically or via pressure swing absorption) from the carbon monoxide, unreacted methanol, by-products, etc., and then collected for storage and/or transport. In examples, separation unit 160 provides for a carbon monoxide stream that is introduced to the steel processing unit via line 150, for example, to reduce or eliminate the introduction of other carbon sources, such as solid carbon sources, e.g., anthracite or other forms of coal.

The particular operating parameters within the catalytic reactor 100 such as temperature, precursor gas residence time, flow rate and methanol decomposition catalyst, may be varied to achieve a soot-free hydrogen stream and carbon monoxide stream.

In examples, the catalyst is disposed in the flow-through decomposition zone as a gas-permeable solid body. In examples, the solid body of catalyst also operates as a heat sink for the thermal energy absorbed by conduction from the off gases. In examples, the decomposition zone is isolated from the flow of off gases by a wall of high heat conductivity material such as a metal wall. In examples, the decomposition zone is enclosed by an elongated cylinder of metal or metal containing material with heat transfer properties suitable for the decomposition of methanol. In examples, the off gases are flowed concurrently or countercurrently past the wall of the zone. In examples, the countercurrent axial flow is used so that the hotter gases are first utilized to decompose methanol and the cooler gases still retain sufficient thermal value to vaporize and/or heat the methanol.

In examples, the body of catalyst is particulate, or a monolithic, integral porous mass. In examples, the catalyst is fabricated in monolithic form. In examples, the reactor is a series of elongated axial tubes containing an insert of permeable monolithic form. In examples, the reactor is a series of elongated axial tubes containing an insert of permeable monolithic catalyst. In examples, the monolithic catalyst insert is in the form of an irregular mesh or sponge-like body or a solid, cylindrical insert element containing a plurality of elongated, continuous, parallel passages. In examples, the insert is formed of high heat conductivity ceramic or metal containing a coating of catalyst on the surface of the passages. In examples, the catalyst is bound via a higher surface area material or washcoat, according to methods commonly used in catalyst preparation.

In examples, the catalysts for efficiently and selectively decomposing methanol to hydrogen and carbon monoxide include copper or chromium comprising catalyst. In examples, the catalysts for efficiently and selectively decomposing methanol to hydrogen and carbon monoxide include copper-zinc, copper-chromium or zinc-chromium or noble metals such as platinum or palladium. In examples, binary catalysts such as copper-zinc are present as separate components, or as an alloy, and can contain other ingredients such as rare earth elements. In examples, the catalysts can be provided in pure form or can be coated on the surface of a solid support such as alumina pellets in an amount from 0.1 to 20% by weight of the pellets, 0.2 to 15% by weight of the pellets, 0.3 to 10% by weight of the pellets, or 0.5 to 5% by weight of the pellets.

Referring now to FIG. 2, a more detailed schematic representation of the exemplary catalytic reactor 100 is shown. The reactor 100 has insulated walls 102 to minimize radiant heat loss. Off gas from steel processing unit is introduced into the reactor 100 as shown. The heat from the hot gas is transferred, which in turn transfer the heat to the catalyst and methanol gas therein. In examples, baffles are provided for circulating the off gases evenly around the reactor. The partially cooled off gases are passed (as shown by curving arrows 106) around the reactor and into vaporizer 124 through access 124 and passed through heat exchange tubes and collected in outlet and are exhausted through one or more outlets. The remaining heat in the partially cooled off gases is absorbed by the vaporizer 124 to vaporize the methanol liquid into methanol vapor, as shown by arrows 112, which flow into the catalyst. If sufficient heat is present in the partially cooled off gas, the methanol may also be superheated above vaporization temperatures in the vaporizer 124.

FIG. 2 is a cross section of exemplary reactor 100 showing an end view of the metal cylinders 202 containing catalyst 202 (shown as monolithic tubes that can be metal coated). FIG. 3 is a detailed elongated sectional view of the monolithic catalyst construct of FIG. 2 showing the plurality of elongated continuous parallel passageways for off gas heating.

In examples, the present method is performed with as short a residence time as possible with the highest practical space velocity so as to provide hydrogen/carbon monoxide formation at the 180° to 800° C. temperature of typical off gases.

Referring to FIG. 2, the catalytic reactor 100 is shown in combination with a steel processing unit, for example, an electric arc furnace 28. In examples, liquid methanol for use in the present system is stored in reservoir 135. The liquid methanol is fed through line 136 to pump 138 at a necessary pressure for pumping the liquid fuel into the vaporizer 124. Valve 140 is provided for controlling the flow of liquid methanol to vaporizer 124.

As previously described, the methanol is passed via feed line 132 into the catalytic reactor 100 where the methanol is thermo-catalytically decomposed to a combined hydrogen and carbon monoxide stream that is transported via line 134. In examples, the combined hydrogen and carbon monoxide stream in line 134 is optionally introduced into a cooler or heat exchanger 143, for example, if the temperature of the stream is above a desired threshold.

In examples, the combined hydrogen and carbon monoxide stream in line 134 is introduced into separator 144. The separator 144 separates the combined hydrogen and carbon monoxide stream from line 134, with carbon monoxide stream being introduced through line 44 into electric arc furnace 28, and hydrogen stream being introduced through line 49 into storage tank 52.

For a given system, the amount of methanol that can be decomposed depends on the temperature and amount of heat provided by the steel processing equipment. This, in turn, depends on the required power level and the equivalence ratio that is used. For an equivalence ratio of unity, the off gas must be cooled by an amount in order to provide the required heat for complete decomposition of the methanol. At lower equivalence ratios, the temperature drop required is less. After a decomposition cycle has started, the upstream off gas temperatures are be maintained for a given equivalence ratio so as to be adequate for catalytic decomposition of the methanol to essentially hydrogen and carbon monoxide.

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

I claim:

1. A system comprising:
a steel processing unit having a residual heat source;
at least one conversion reactor configured to receive a first material having a first heating value, the at least one conversion reactor being coupled to the residual heat source, the at least one conversion reactor configured to catalytically convert the first material to a second material having a second heating value greater than the first heating value.

2. The system of claim 1, wherein the residual heat source is from off gas that is inductively, convectively, or radiatively transferred.

3. The system of claim 1, wherein the steel processing unit is an electric arc furnace, a blast furnace, or a direct reduction unit.

4. The system of claim 1, wherein the first material is methanol.

5. The system of claim 1, wherein the first material is heated to a temperature from ambient to about 180° C. prior to being received by the at least one conversion reactor.

6. The system of claim 1, wherein the first material is vaporized prior to being received by the at least one conversion reactor.

7. The system of claim 1, wherein the second material is hydrogen.

8. The system of claim 1, wherein the system further comprises collecting or storing the hydrogen.

9. The system of claim 1, wherein the at least one conversion reactor is thermally coupled to the steel processing unit.

10. The system of claim 1, wherein the at least one conversion reactor is configured to receive the first material at a temperature from ambient to about 180° C.

11. The system of claim 1, wherein the at least one conversion reactor comprises a catalyst selected from copper-zinc, copper-chromium or zinc-chromium.

12. The system of claim 1, wherein the at least one conversion reactor is configured to catalytically convert the first material to a third material, wherein the third material is carbon monoxide, for introduction to the steel processing unit.

13. A method comprising:
providing at least one conversion reactor thermally coupled to a residual heat source of a steel processing unit;
receiving a first material having a first heating value, wherein the first material is methanol;
catalytically converting the first material to a second material having a second heating value greater than the first heating value, wherein the second material is hydrogen.

14. The method of claim 13, wherein the steel processing unit is an electric arc furnace, a blast furnace, or a direct reduction unit.

15. The method of claim 13, heating the first material to a temperature from ambient to about 180° C. prior to being received by the at least one conversion reactor.

16. The method of claim 13, further comprises collecting or storing the hydrogen.

17. The method of claim 13, heating the at least one conversion reactor to a temperature from 180° C. to 800° C.

18. The method of claim 13, wherein the at least one conversion reactor comprises a catalyst selected from copper-zinc, copper-chromium or zinc-chromium.

19. The method of claim 13, further comprising catalytically convert the first material to a third material, wherein the third material is carbon monoxide.

20. The method of claim 13, further comprising introducing the third material to the steel processing unit.

21. A method of reducing or eliminating solid carbon introduction into a steel process, the method comprising:
providing at least one conversion reactor thermally coupled to a residual heat source of a steel processing unit;
receiving methanol in the at least one conversion reactor;
catalytically converting the methanol to a carbon monoxide stream and a hydrogen stream;
separating the carbon monoxide stream from the hydrogen stream; and
introducing the carbon monoxide stream into the steel processing unit so as to reduce or eliminate solid carbon introduction.

22. The method of claim 21, wherein the steel processing unit is an electric arc furnace, a blast furnace, or a direct reduction unit.

23. The method of claim 21, heating or vaporizing the methanol to a temperature from ambient to about 180° C. prior to being received by the at least one conversion reactor.

24. The method of claim 21, wherein the at least one conversion reactor is configured to continuously or semi-continuously receive the methanol and continuously or semi-continuously produce the carbon monoxide stream and the hydrogen stream.

25. The method of claim 21, heating the at least one conversion reactor to a temperature from 180° C. to 800° C.

26. The method of claim 21, further comprises collecting or storing the hydrogen stream.
